(19) United States
(12) Patent Application Publication
(10) Pub. No.: US 2011/0101285 A1
(43) Pub. Date: May 5, 2011

(54) CONDUCTIVE PASTE WITH SURFACTANTS

(76) Inventors: Chu-Lung Chao, Taoyuan County (TW); Yu-Chen Chang, Hsinchu County (TW); Chong-Chieh Cheng, Taipei City (TW); Ying-Chih Lu, Kaohsiung City (TW); Cheng-Hsun Lin, Taipei County (TW); Wen-Jui Huang, Hsinchu City (TW)

(21) Appl. No.: 12/717,110

(22) Filed: Mar. 3, 2010

(30) Foreign Application Priority Data
Oct. 29, 2009 (TW) 098136633

(51) Int. Cl. H01B 1/22

(52) U.S. Cl. 252/512

(57) ABSTRACT

A conductive paste includes: at least one metal powder, an organic vehicle, a glass and a surfactant having a representative formula as follows: Mₓ(R)_{y}(Q)_{z}, wherein M is selected from a metal element and a semiconductive element, R is hydrophilic group directly connected to M and one will be able to hydrolyze by water to form another hydrophilic group, and Q is a hydrophobic group. The hydrophilic functional group of the surfactant will attach on the metal powder surface closely. Therefore, the surfactant can disperse the metal powder in the organic vehicle well and prevent paste from aggregating.

### BACKGROUND OF THE INVENTION

1. Field of the Invention

The present invention generally relates to a conductive paste. In particular, the present invention is directed to a conductive paste with a surfactant.

2. Description of the Prior Art

Because the internet-related and electronic-related techniques are developing more and more rapidly so that various older electronic products are being replaced by other newer ones and their size is shrinking quickly, the size of the elements for connecting the electric patterns, and for connecting the electric patterns and other elements is shrinking quickly, as well. Since conductive paste can be cured instantly or quickly, conveniently manipulated, and forms a layer which is usually smaller than conventional connecting elements such as pins, it is often used in electronic products.

Additionally, solar cells which use single-crystal Si or poly Si as their main semiconductor substrate have electrodes which use conductive pastes made of mixed metal powders and organic vehicles applied on Si wafers by screen printing and sintered in sintering furnaces. Accordingly, the composition and the sintering condition of the conductive paste are especially critical to the solar cells.

Generally speaking, a conductive paste includes an organic vehicle, conductive powders, glass frits and optional additives. The components in the conductive paste dominate the shape after printing, the conductivity of the electrodes, adherence to the semiconductor substrate and etching of the anti-reflective later.

The above-said glass frit usually includes some ingredients to etch the anti-reflective layer and to assist the sintering during the thermal sintering process. However, such ingredients and the glass itself are pollutants and harmful to the environment during the manufacture and usage.

As a result, a novel and environment-friendly conductive paste is still needed to keep the solar cell stable, to maintain high conversion yield and make it less harmful to the environment.

### SUMMARY OF THE INVENTION

The present invention accordingly proposes a conductive paste for use in electronic products. In particular, the conductive paste of the present invention is particularly useful in the electrodes of solar cells.

The present invention proposes a conductive paste which includes at least one metal in powder form, an organic vehicle, glass frit and a surfactant. The surfactant has a representative formula as follows:

Mₓ(R)_{y}(Q)_{z}

wherein,

M is a metal element or a semiconductive element, such as Al, Ti, Zr or Si . . . etc.;

R is hydrophilic group which is directly connected to M, and R is capable of being hydrolyzed by water to form a corresponding hydrophilic functional group, such as alkyl oxide group, carbonyl group, carboxyl group, carbonyloxy group, or amido group; and

Q is a hydrophobic group with 1-24 carbon atoms, and Q may be a stable and less reactive alkyl group or alkoxy group, or includes a functional group which is capable of reacting with other polymeric units or moieties, such as vinyl group, aliphatic epoxy group, styryl group, methacryloxy group, acryloxy group, aliphatic amino group, chloropropyl group, aliphatic mercapto group, aliphatic sulfido group, isocyanato group, aliphatic ureido group, aliphatic carboxyl group, aliphatic hydroxyl group, cyclohexyl group, phenyl group, aliphatic formyl group, acetyl group, or benzoyl group. Due to the functional groups which are capable of reacting with other polymeric units, there may be one or more surfactants of the present invention which are linked to one polymeric chain such as Mₓ(R)_{y}(Q)_{z}. The surfactant which is attached to a polymeric chain may be one or more.

The surfactant of the present invention has a representative formula as follows:

Mₓ(R)_{y}(Q)_{z}

wherein,

X, Y and Z are all natural numbers.

Because the conductive paste of the present invention employs a specially designed surfactant, the hydrophilic group R in the surfactant may turn into another hydrophilic functional group after being hydrolyzed by water, but the hydrophobic group Q has greater affinity to organic solvents or is prone to react with polymers. The hydrophilic functional group in the surfactant is prone to attach to the surface of metals and the other hydrophobic group Q has greater affinity to organic solvents. In such a way, metal powders may be accordingly well dispersed. Furthermore, the glass content may become lower as compared to the conventional conductive paste when the surfactant is added into the conductive paste so that it introduces less contaminants into the environment.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a reaction in which the surfactant of the present invention bonds with a side chain of a polymer.

FIG. 2 illustrates the hydrolysis reaction of Formula 1.

FIG. 3 illustrates the hydrolysis reaction of Formula 2.

FIG. 4 (Table 1 to Table 3) illustrates the compositions of the conductive paste with the addition of the surfactant of Formula 1 of the present invention.

FIG. 5 (Table 4) illustrates the results of electric properties, tensile and bow reduction between examples and comparative examples in Table 1 to Table 3.

### DETAILED DESCRIPTION

The present invention provides a conductive paste which includes at least one metal material in powder form, an organic vehicle, optional glass and a surfactant. The metal may be Al powder or Ag powder. The organic carrier is dissolved resins in an organic solvent with optional oil acid or other additives. The glass may be an amophorous compound containing metals in various oxide forms, mainly for etching the anti-reflective of solar cells and to assist the sintering during the thermal sintering process. To meet different demands, different glass may be added or no glass is added.

The surfactant which is provided by the present invention has a representative formula as follows:

Mₓ(R)_{y}(Q)_{z} representative formula 1

wherein X is between 1 and 6, Y is between 1 and 20 and Z is between 1 and 20, M is a metal element or a semiconductive element, such as Al, Ti, Zr, Si, Ge or other metal elements and semiconductive elements, R is hydrophilic group which is directly connected to M, and R is capable of being hydrolyzed by water to form a corresponding hydrophilic functional group. In accordance with the present invention, R may independently be an alkyl oxide group (—O—CₘHₙ), carbonyl group (—(C═O)—CₘHₙ), carboxyl group (—O—(C═)—CₘHₙ), carbonyloxy group (—(C═O)O—CₘHₙ), amido group (—(C═O)NH—CₘHₙ), alkoxylene group (—O—CₘHₙ—O—) and carboxylic ester group (—O—(C═O)—CₘHₙ—O—). Generally speaking, m may be between 1 and 6, n may be between 3 and 13, CₘHₙ may be a branched or unbranched alkyl or cycloalkyl group. The alkoxylene group may be ethoxylene (—O—CH₂—CH₂—O—), and the carboxylic ester group may be (—O—(C═O)—CH₂—O—).

Q is a hydrophobic group with 1-24 carbon atoms. Q may be a stable and less reactive alkyl group or alkoxy group, or include a functional group which is capable of reacting with other polymeric units or moieties, such as a vinyl group, aliphatic epoxy group, styryl group, methacryloxy group, acryloxy group, aliphatic amino group, chloropropyl group, aliphatic mercapto group, aliphatic sulfido group, isocyanato group, aliphatic ureido group, aliphatic carboxyl group, aliphatic hydroxyl group, cyclohexyl group, phenyl group, aliphatic formyl group, acetyl group or benzoyl group. The aliphatic group may have 1-24 carbon atoms, such as a branched or unbranched alkyl group.

In addition to this, Q may also be a compound including N, O, P S, or the combination thereof. In some circumstances, Q may have at least one long pair which M may accept so that Q is a ligand when M is a metal. Furthermore, Q is capable of being chemically bonded to be a side chain or a terminal of a polymer chain by means of chemical reaction through the functional group, which means a polymeric chain may connect one or more functional groups of the surfactant Mₓ(R)_{y}. In other words, the surfactant which is attached to a polymeric chain is not limited to just one type. As long as a polymeric chain is able to react with Q, it is a suitable polymeric chain. The polymeric chain may have 1 to 10000 polymeric units.

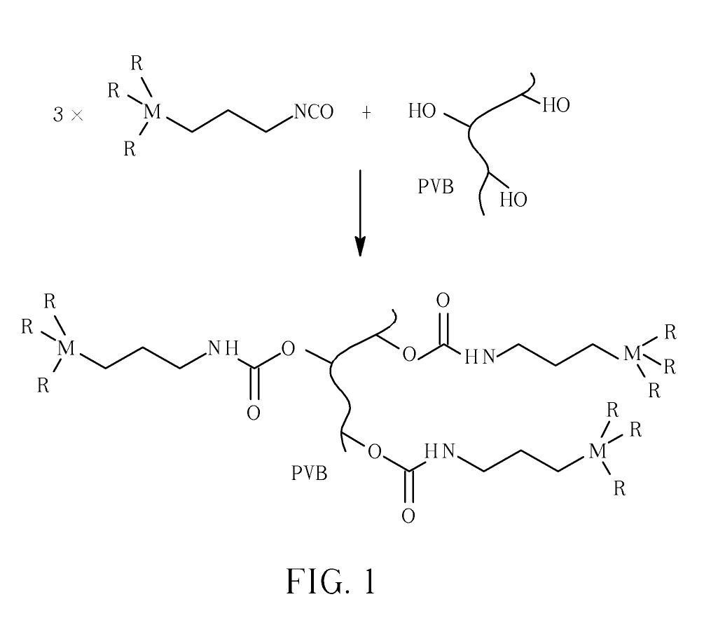

FIG. 1 illustrates a reaction in which the surfactant of the present invention bonds with a side chain of a polymer. As shown in FIG. 1, the side chain of a polymer has hydroxyl groups —OH. The polymer may be a polyvinyl alcohol (PVA) or a polyvinyl butyral (PVB). Taking PVB for example as shown in FIG. 1, the polymer reacts with Q having isocyanate group, —NCO, to form a urethane group, —NH—CO—O—, which makes Mₓ(R)_{y} attached to the polymer.

A preferred embodiment of the representative formula 1 of the present invention may be the compound of formula 1, formula 2, formula 3 or formula 4. However, these embodiments are for illustration purposes only and the scope of the present invention is not therefore limited.

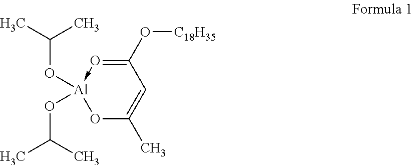

In formula 1, M is illustrated as Al. As a result, X is 1. R is an isopropoxy group, i.e. (CH₃)₂CHO— which is attached to Al. There are two isopropoxy groups therein, so Y is 2. Since Q is (O—C(CH₃)—CH—CO—O—C₁₈H₃₅), Z is 1. In formula 1, on one hand Q is bonded to M. And on the other hand, Q may also serve as a ligand, a bidentate for instance so that Q and M have coordination bonding to each other. In addition, in accordance with the demands of different products R may be selected from different hydrophilic groups. For example, one of R may be an isopropoxy group and the other R may be another group such as a carbonyl group or a carboxyl group.

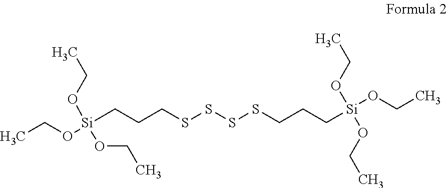

In formula 2, X is 2 since M is illustrated as Si. R is an ethoxy group, i.e. —O—C₂H₅, so Y is 6. Q is C₃H₆S₂ so Z is 2. In formula 2, Q is a divalent group which is capable of bonding to two independent Ms, and there are hetero-atoms in Q, S for example.

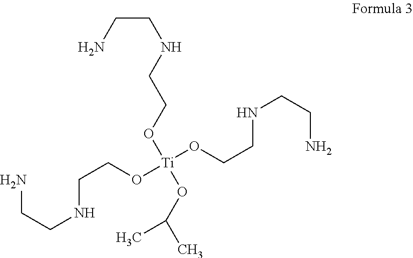

In formula 3, X is 1 because M is illustrated as Ti. R is an isopropoxy group, i.e. (CH₃)₂CHO—, so Y is 1. Q is —OC₂H₄NHC₂H₄NH₂ so Z is 3.

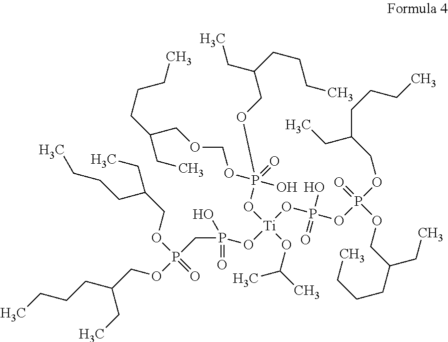

In formula 4, X is 1 because M is illustrated as Ti. R is an isopropoxy group, i.e. (CH₃)₂CHO—, so Y is 1. Q is —P₂O₅H—(OC₈H₁₇)₂ so Z is 3.

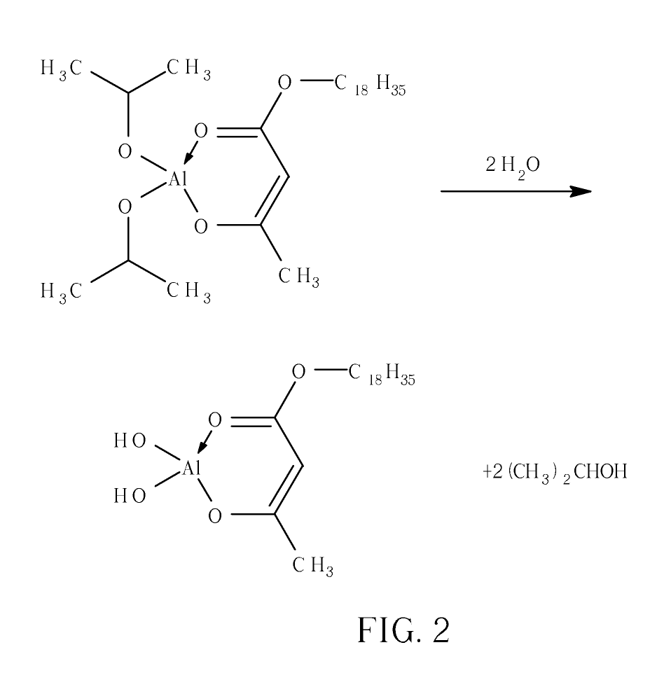

FIG. 2 illustrates the hydrolysis reaction of Formula 1. As shown in FIG. 2, taking Formula 1 for example, water in an organic carrier may hydrolyze Formula 1 when Formula 1 is in contact with the organic carrier. The original (CH₃)₂CO—)₂ group in R which reacted with water molecules now turns into (HO—)₂ groups which correspond to the original (CH₃)₂CO—)₂ group. At this moment, (HO—)₂ groups may adsorb onto the surface of metal powders and the hydrophobic group Q is dissolved in the organic carrier.

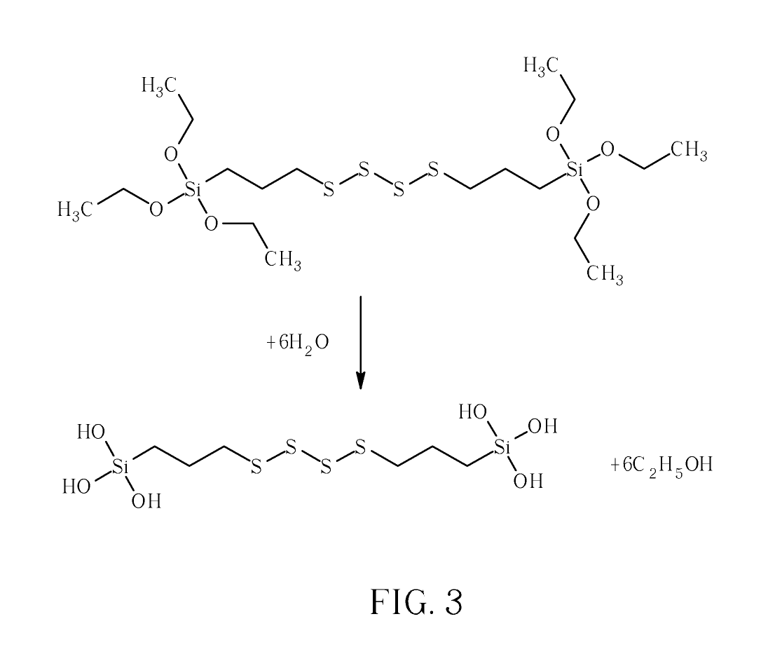

FIG. 3 illustrates the hydrolysis reaction of Formula 2. As shown in FIG. 3, R in Formula 2 is an ethoxy group, i.e. —O—C₂H₅. After reacting with water molecules, it turns into (HO—)₂ groups which corresponds to the original ethoxy group. At this moment, (HO—)₂ groups may adsorb onto the surface of metal powders and the hydrophobic group Q (C₃H₆S₂) is dissolved in the organic carrier.

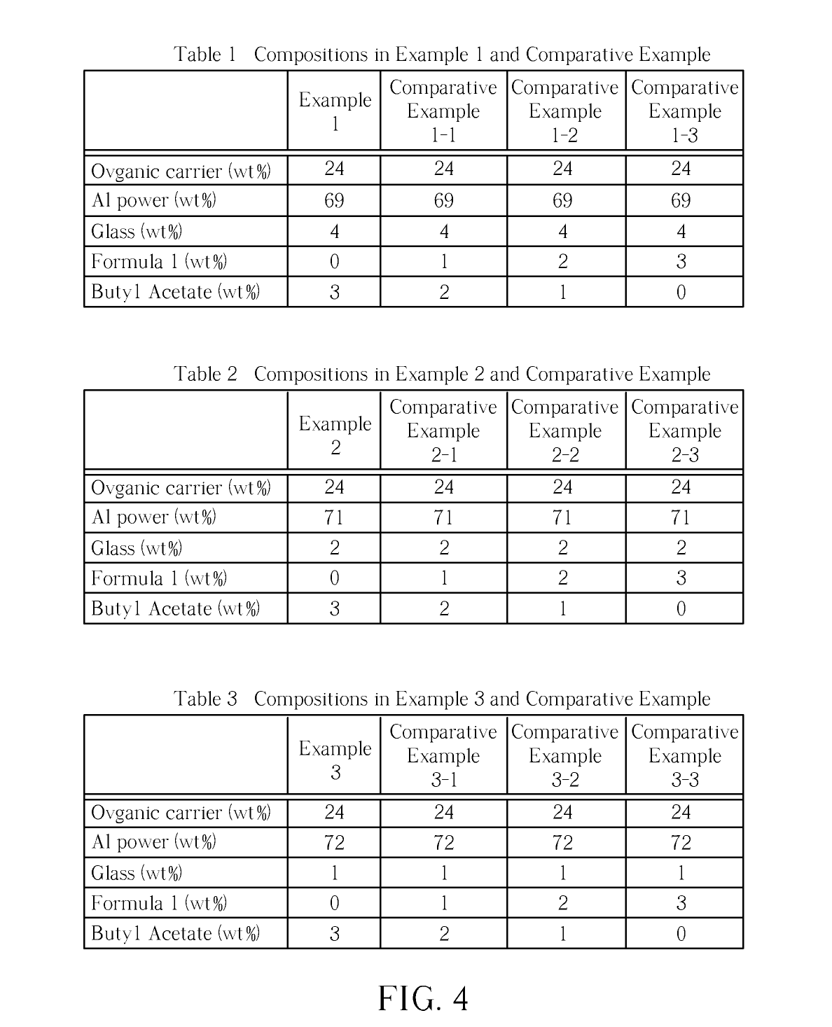

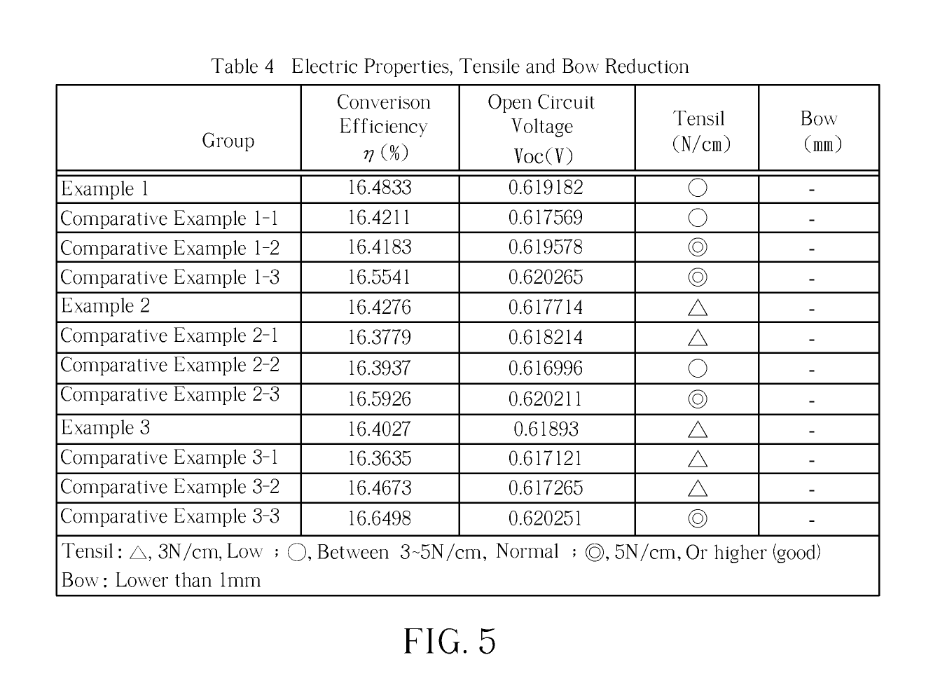

Table 1 to Table 3 in FIG. 4 illustrate the compositions of the conductive paste with the addition of the surfactant of Formula 1 of the present invention. Table 4 in FIG. 5 illustrates the results of electric properties, tensile and bow reduction between examples and comparative examples in Table 1 to Table 3.

As shown in FIG. 4, under the circumstance of higher glass content (4%), the addition of surfactant may increase the tensile. Under the circumstance of lower glass content (1%-2%), the surfactant may also increase the tensile to an acceptable extent which meet the requirements of this field without affecting the electrical properties.

Accordingly, the surfactant of the present invention not only can effectively disperse the metal powders, but also 10% (wt. %) or less, preferably 0.1%-5% (wt. %), surfactant in the conductive paste is sufficiently effective. In the conventional methods, there is no other way to increase the connection between the electrodes of the solar cells and the semiconductor substrate in addition to the addition of glass into the conductive paste. However, in the presence of the conductive paste of the present invention, less glass is required. Less glass does less harm to the environment and makes no harm to the connection between the electrodes of the solar cells and the semiconductor substrate. Further, the efficiency of solar cells keeps substantially unchanged.

Moreover, the conductive paste of the present invention may not only be used in solar cells, but also may be used in other electronic elements such as ceramic capacitors, semiconductor packaging, or printed circuit boards.

Those skilled in the art will readily observe that numerous modifications and alterations of the device and method may be made while retaining the teachings of the invention.

What is claimed is:

1. A conductive paste comprising:
at least one metal powder;
an organic carrier;
a glass; and
a surfactant having a representative formula as follows:
Mₓ(R)_{y}(Q)_{z},
wherein M is selected from a group consisting of a metal element and a semiconductive element;
R is a hydrophilic group, wherein said hydrophilic group which is chemically bonded to M is capable of being hydrolyzed by water to form a hydrophilic functional group; and
Q is a hydrophobic group, wherein X is between 1 and 6, Y is between 1 and 20 and Z is between 1 and 20.

2. The conductive paste of claim 1, wherein Q has a long pair which M accepts to be a ligand.

3. The conductive paste of claim 1, wherein M comprises at least one of Al, Ti, Zr, and Si.

4. The conductive paste of claim 1, wherein R is selected from the following group: alkyl oxide group (—O—CₘHₙ), carbonyl group (—(C═O)—CₘHₙ), carboxyl group (—O—(C═O)—CₘHₙ), carbonyloxy group (—(C═O)O—CₘHₙ), amido group (—(C═O)NH—CₘHₙ), alkoxylene group (—O—CₘHₙ—O—) and carboxylic ester group (—O—(C═O)—CₘHₙ—O—).

5. The conductive paste of claim 4, wherein m is between 1 and 6.

6. The conductive paste of claim 4, wherein n is between 3 and 13.

7. The conductive paste of claim 1, wherein Q comprises at least one of N, O, P and S.

8. The conductive paste of claim 1, wherein Q is selected from the following groups: vinyl group, aliphatic epoxy group, styryl group, methacryloxy group, acryloxy group, aliphatic amino group, chloropropyl group, aliphatic mercapto group, aliphatic sulfido group, isocyanato group, aliphatic ureido group, aliphatic carboxy group, aliphatic hydroxyl group, cyclohexyl group, phenyl group, aliphatic formyl group, acetyl group and benzoyl group.

9. The conductive paste of claim 1, wherein said aliphatic group comprises 1 to 24 carbon atoms.

10. The conductive paste of claim 1, wherein Q is capable of being chemically bonded to a side chain or a terminal of a polymer chain by means of a chemical reaction.

11. The conductive paste of claim 10, wherein said polymer chain has 1 to 10000 polymeric units.

12. The conductive paste of claim 1 comprising 10% or less of said surfactant.
